(19) United States
(12) Patent Application Publication
(10) Pub. No.: US 2025/0097830 A1
(43) Pub. Date: Mar. 20, 2025

(54) CONTROLLING ACCESS-POINT OPERATION USING A CONTEXT AWARE CLIENT DEVICE

(71) Applicant: Samsung Electronics Co., Ltd., Suwon-si (KR)

(72) Inventors: Vishnu Vardhan Ratnam, Frisco, TX (US); Abhishek Sehgal, Frisco, TX (US); Boon Loong Ng, Plano, TX (US); Yuming Zhu, Plano, TX (US)

(21) Appl. No.: 18/792,479

(22) Filed: Aug. 1, 2024

Related U.S. Application Data
(60) Provisional application No. 63/539,489, filed on Sep. 20, 2023.
(60) Provisional application No. 63/626,722, filed on Jan. 30, 2024.

(51) Int. Cl. H04W 48/16; H04L 45/302

(52) U.S. Cl. CPC H04W 48/16; H04L 45/302

(57) ABSTRACT

Techniques for using contextual information from a host STAs in the context of a wireless network having at least one non-AP station (STA) are disclosed. The host STA uses transmitted fields from the AP to determine a make of the AP. The host STA sends a request message to control one or more AP parameters to the AP. The host STA, if the AP accepts the message, sends another message identifying the STAs in its network. The host STA also acquires, via a message from the AP, details about the STAs associated with the AP. When receiving contextual information from itself or otherwise, the host STA determines an appropriate action, and transmits an action request message for the AP to take the action. The AP confirms once the action is taken.

### CROSS-REFERENCE TO RELATED APPLICATIONS

This application claims the benefit of priority from (i) U.S. Provisional Application No. 63/539,489 filed Sep. 20, 2023 and entitled “Method And Apparatus For Controlling Access-Point Operation Using A Context Aware Client Device” and (ii) U.S. Provisional Application No. 63/626,722 filed Jan. 30, 2024 and entitled “Controlling Access-Point Operation Using A Context Aware Client Device,” which are incorporated by reference as if expressly set forth herein.

### TECHNICAL FIELD

This disclosure relates generally to wireless communication, and more particularly to, for example, but not limited to, controlling access-point operation in wireless local area networks (WLANs).

### BACKGROUND

Wireless local area network (WLAN) technology has evolved toward increasing data rates and continues its growth in markets such as home, enterprise and commercial “hotspots” over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. The IEEE 802.11 family of standards aims to increase speed, reliability, and versatility, and to extend operating range, among numerous other benefits. The WLAN is formed within a limited area such as a home, school, apartment, or office building by WLAN devices. Each WLAN device may have one or more stations (STAs) such as an access point (AP) STA and the non-access-point (non-AP) STAs.

Harnessing growing interest in these wireless networks are models using so-called host stations (host STAs) with an AP and one or more other STAs. It is desirable to optimize the quality of experience (QoE) in these systems. The features these systems provide should be capable of being dynamically updated based on contextual information to maximize user experience. Among other problems, existing proposals for providing an AP unable to directly obtain this contextual information result in performance shortcomings.

The description set forth in the background section should not be assumed to be prior art merely because it is set forth in the background section. The background section may describe aspects or embodiments of the present disclosure.

### SUMMARY

In one aspect of the disclosure, an access point (AP) is provided. The AP includes a memory and a processor coupled to the memory, The processor is configured to receive, from a host station (host STA), a parameter control request that requests authorization to provide contextual information to the AP and control one or more basis service set (BSS) parameters for one or more stations (STAs) associated with the AP. The processor is further configured to transmit, to the host STA, a parameter control response that indicates authorization to the parameter control request. The processor is further configured to receive, from the host STA, contextual information associated with one or more BSS parameters for the one or more STAs.

In various embodiments, the processor is further configured to control the transmission and scheduling parameters for one or more STAs and the BSS parameters.

In various embodiments, based on the contextual information, the processor is further configured to control the transmission and scheduling parameters for one or more STAs and the BSS parameters.

In various embodiments, the processor is further configured to transmit to the host STA one or more frames comprising information associated with a make of the AP and a capability of the AP to receive parameter control requests from the host STA.

In various embodiments, the processor is configured to perform an authorization check upon receiving the parameter control request from the smart hub before responding to the parameter control request.

In various embodiments, the parameter control request includes an authentication code, and one or more request types or identifiers of one or more STAs associated with the AP for which the request is applicable.

In various embodiments, upon receiving the authorization, the processor is configured to send an associated STA report to the host STA identifying one or more STAs associated with the AP and parameters of the AP including link characteristics and traffic characteristics.

In various embodiments, the processor is configured to receive from the host STA a device type report identifying types of the one or more STAs associated with the AP and parameters of the AP including traffic characteristics.

In various embodiments, the processor is configured to receive the contextual information via an action request message from the host STA to perform an action on the BSS parameters or on the one or more STAs on behalf of the host STA, the action including: (i) setting up or removing a virtual BSS using login credentials; (ii) enabling or disabling availabilities of one or more STAs in the wireless network; (iii) enabling or disabling links with any of the one or more STAs if the STA is a multi-link device (MLD); (iv) increasing or decreasing a maximum supported bandwidth or number of spatial streams of the AP; (v) changing quality of service (QOS) criteria used for the at least one STA for all or designated traffic flows to the at least one STA of the one or more STAs; (vi) changing transmit power for signals sent from the at least one STA, (vii) changing an operating channel with the host STA; or (viii) restricting transmission of uplink or downlink frames for a specified time interval to or from the at least any of the STAs.

In various embodiments, upon determining the appropriate action to take based on the shared contextual information, and based on the determination, the processor is configured to send an action response message to the host STA to indicate a result of the determination.

In various embodiments, upon receiving an action request message to change transmission and scheduling parameters for at least one associated STA, the processor is configured to send a notification message to the at least one associated STA to indicate the change in parameters.

Another aspect of the disclosure is provided. A host station (host STA) includes a memory and a processor. The processor is coupled to the memory and configured to transmit, to an access point (AP), a parameter control request that requests authorization to provide contextual information to an AP and control one or more Basic Service Set (BSS) parameters for one or more stations (STAs) associated with the AP. The processor is further configured to receive, from the AP, a parameter control response that indicates authorization to the parameter control request. The processor is further configured to transmit, to the AP, contextual information associated with one or more BSS parameters for the one or more STAs.

In various embodiments, the processor is further configured to propose changes to information transmitted by the AP in a wireless network based on the transmitted contextual information.

In various embodiments, the processor is further configured to receive from the AP one or more frames comprising information associated with a make and capabilities of the AP to receive parameter control requests.

In various embodiments, the authorized parameter control response enables the host STA to receive action control responses seeking particular types of contextual information.

In various embodiments, the parameter control request includes an authentication code, one or more request types, and one or more STAs.

In various embodiments, the processor is configured to transmit an AP action request message to provide the AP with recommendations for taking different actions responsive to different network criteria and conditions.

In various embodiments, wherein upon receiving control response, the processor is configured to send an associated STA report to the host STA identifying one or more STAs.

In various embodiments, wherein the processor identifying a critical STA of the one or more STAs having substandard performance that requires immediate improvement, the processor is configured to transmit the Quality of Service (QOS) requirements to the AP on behalf of the critical STA.

In various embodiments, the QoS requirements are carried in the Quality of Service (QoS) characteristics element of the AP Action request message.

In various embodiments, the QOS requirements along with the identifiers of the one or more affected traffic flows of the critical STA are carried in the Stream Classification Service (SCS) descriptor element of the AP Action request message.

### BRIEF DESCRIPTION OF THE DRAWINGS

FIG. 1 shows an example of a wireless network in accordance with an embodiment.

FIG. 2A shows an example of an AP in accordance with an embodiment.

FIG. 2B shows an example of a STA in accordance with an embodiment.

FIG. 3 shows an example of multi-link communication operation in accordance with an embodiment.

FIG. 4 is an illustrative depiction of a channel switch announcement operation element.

FIG. 5 is an example illustration of a channel switch announcement operation element.

FIG. 6 is an example illustration of an extremely high throughput (EHT) capabilities operation element group.

FIG. 7 is an example illustration of an enhanced distributed channel access (EDCA) set.

FIG. 8 is an example of the transmit power envelope for the Wi-Fi network.

FIG. 9 is an example illustration of the Quiet element used by an AP to restrict the transmission of frames during select times.

FIG. 10 is an example illustration of a Quality-of-Service (QOS) Characteristics element used by the AP to provide preferred limitations or functions to select STAs for certain time durations.

FIG. 11 is an example conceptual diagram of a system model depicting an AP, associated STAs, and a Smart Home Hub for providing contextual information to the AP, in accordance with an embodiment.

FIG. 12 is an example illustration of a UHR capabilities element including an indication of AP Parameter Control Support, in accordance with an embodiment

FIG. 13 is an example signaling diagram showing an exchange between a host STA and an AP effectuated to secure approval by the host STA to control the AP in some authorized way, in accordance with an embodiment.

FIG. 14A is a frame in a wireless local area network for carrying information relevant to an AP Parameter Control Request message, in accordance with an embodiment.

FIG. 15A is an illustrative example of an Associated STA Report sent by an AP based on a request from a SHD or a host STA, in accordance with an embodiment.

FIG. 15B is an example of a frame for illustrating the device type report sent by a SHH/SHD to an AP to identify the device types of one or more associated STAs, in accordance with an embodiment.

FIG. 16A is an illustration of an AP Action Request message where a QoS Characteristic element is directly included, in accordance with an embodiment.

FIG. 16B depicts an illustration of an AP Action Request message, where the QoS Characteristic is carried in a Stream Classification Service (SCS) Descriptor element, in accordance with an embodiment.

FIG. 17A is a signaling diagram showing Quality of Service (QOS) provisioning of a STA without eliciting a confirmation from the STA, in accordance with an embodiment.

FIG. 17B is a signaling diagram showing QoS provisioning of a STA upon receiving a confirmation from the STA, in accordance with an embodiment.

FIG. 18 is an illustrative flow diagram representing methods of the disclosure, in accordance with an embodiment.

FIG. 19 is an illustrative flow diagram representing methods of the disclosure, in accordance with an embodiment.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Unless otherwise explicitly specified, the following terms apply to the present disclosure. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, or C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

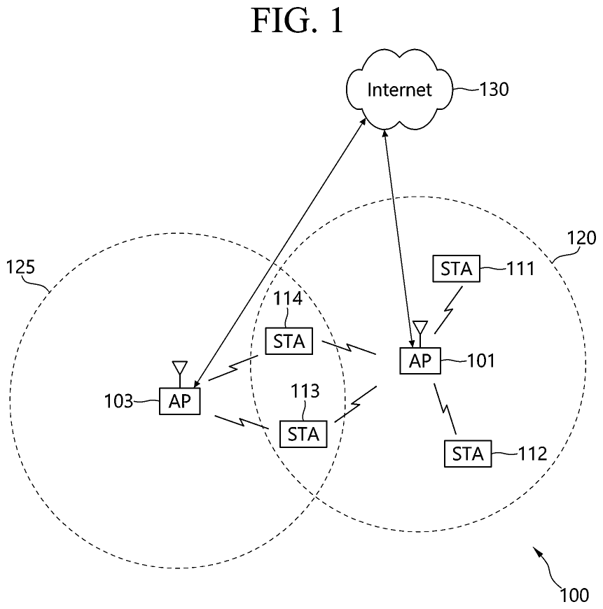

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 includes a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link devices (MLDs). As noted, conventional standards support multiple bands of operation, such that an AP and a non-AP STA can communicate with each other over links. Thus, both the AP and non-AP STA may be capable of communicating on different frequency bands/links, which is referred to herein as multi-link operation (MLO). Devices capable of MLO are referred to as multi-link devices (MLDs). STAs 111-114 are wireless communication devices, each of which may include one or more non-AP STAs. In such embodiments, STAs 111-114 may be non-AP MLDs.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

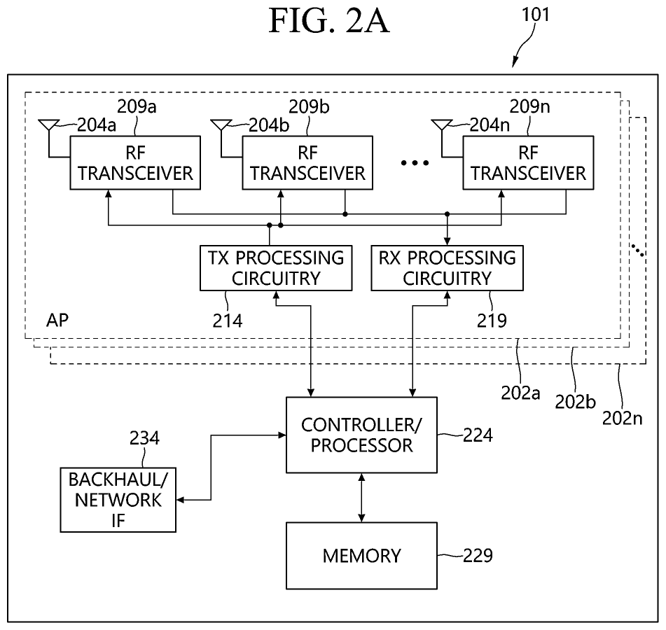

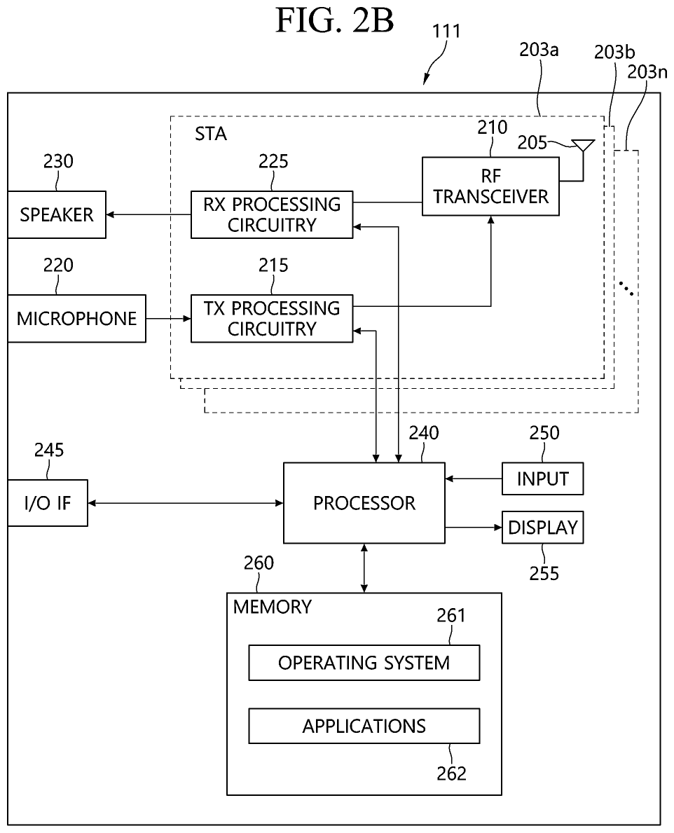

FIG. 2A shows an example of an AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any implementation of an AP.

As shown in FIG. 2A, the AP 101 includes multiple antennas 204a-204n, multiple radio frequency (RF) transceivers 209a-209n, transmit (TX) processing circuitry 214, and receive (RX) processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 may support additional functions as well, such as more advanced wireless communication functions. For instance, the controller/processor 224 may support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of a STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 includes antenna(s) 205, an RF transceiver 210, TX processing circuitry 215, a microphone 220, and RX processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 includes at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the touchscreen 250 and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiments, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

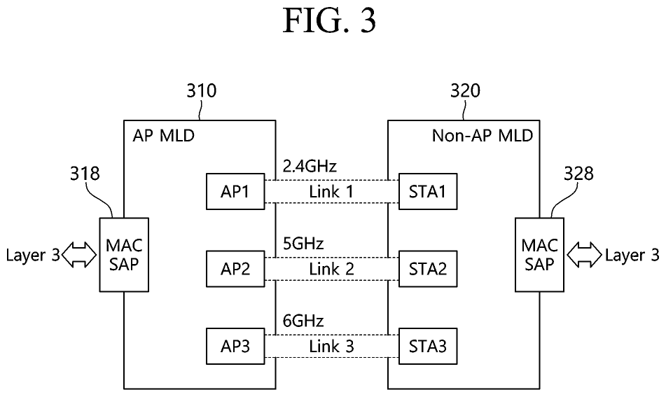

FIG. 3 shows an example of MLD communication operation 300 in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP includes a PHY interface to wireless medium (Link 1, Link 2, or Link 3). The AP MLD 310 includes a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and the Layer 3 recognizes the AP MLD 310 by assigning the single IP address.

The non-AP MLD 320 may include a plurality of affiliated STAs, for example, including STA 1, STA 2, and STA 3. Each affiliated STA includes a PHY interface to the wireless medium (Link 1, Link 2, or Link 3). The non-AP MLD 320 includes a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and the Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency.

To prioritize transmission of different types of traffic, which are identified by a traffic identifier (TID), across the setup links, the non-AP MLD 320 may negotiate a TID-to-link mapping with the AP MLD 310. The TID-to-link mapping allows the AP MLD 310 and the non-AP MLD 320 to determine how frames belonging to TIDs are assigned for transmission on each setup link in the uplink and downlink directions, respectively. When at least one TID associated with a non-AP MLD 320 is mapped to a setup link in either uplink or downlink direction, the link is referred to as an enabled link for the non-AP MLD 320. By default, all TIDs are mapped to all the setup links between the AP MLD 310 and the non-AP MLD 320, and this mapping is referred to as a default TID-to-link mapping. During association, the non-AP MLD 320 can use a negotiation procedure to negotiate a non-default mapping of TIDs to the setup links, by including a TID-to-Link Mapping element in an association request frame or a reassociation request frame. The non-default mapping can be either where all TIDs are mapped to the same subset of setup links, or where not all TIDs are mapped to the same subset of setup links. The AP MLD 310 can also use a broadcast procedure to indicate switching to a non-default mapping for all associated non-AP MLDs. In default mapping mode, all TIDs are mapped to all setup links for downlink and uplink and all setup links are enabled. The non-AP MLD 320 operates under default mapping mode when a TID-to-link mapping negotiation did not occur or was unsuccessful.

The following documents and standards descriptions are hereby incorporated into the present disclosure as if fully set forth herein: (1) IEEE 802.11-2020, “Wireless LAN Medium Access Control (MAC) and Physical Layer (PHY) Specification;” (2) IEEE 802.11ax-2021; and (3) IEEE P802.11be/D3.0.

A description of example embodiments is provided on the following pages. The text and figures are provided solely as examples to aid the reader in understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention. It will be appreciated that the terms “smart home hub (SHH),” “smart hub device (SHD),” and “host Station (host STA)” may be used interchangeably throughout this disclosure, at least for the purposes herein. The host STA has characteristics resembling the SHH, but need not be necessarily located in a home. In other embodiments, the SHD may reside in an office or in another location where the use of wireless networks may be common. The term “host STA” refers broadly to a station in a wireless network with host capabilities. An infrastructure Wi-Fi network or basic service set (BSS) typically has the two types of devices described in greater length above: an AP and one or more (non-AP) STAs. An AP is typically connected to a wired network and provides wireless connectivity to the STAs that are associated with it. As an enhancement, the specification cited above, IEEE 802.11be, introduced multiple bands of operation, such that an AP and a non-AP device can communicate with each other such as by using links. Examples of links from FIG. 3 include Links 1-3; however, other links may be contemplated and are understood as being within the scope of the present disclosure.

The AP performs scheduling of downlink and/or uplink traffic within its BSS to ensure that the demands of its clients are met satisfactorily. To control the performance of the network and the access to the medium, the AP also has different mechanisms. For example, the AP can dictate the maximum bandwidth that can be used for communication with one or more STAs. The maximum bandwidth of the operation of the BSS is disclosed by the AP in the HT/VHT/HE/EHT Operation element (OE) (also referred to as “information element” (IE), or in some cases, “field,” “subfield,” “frame,” “set,” “group.” and/or “subframe,” or terms of like import) that it includes in probe response and beacon frames. This OE includes the (i) Channel Width subfield to indicate the BSS bandwidth, (ii) Channel Center Frequency Segment (CCFS) 0 field to indicate the center frequency of the primary channel for the BSS and (iii) Channel number of the primary 20 MHz channel. An illustration of the EHT Operation element is depicted in FIG. 3 below. An AP also indicates its capability to receive different channel widths (that is, smaller than the max Channel width) in the PHY Capabilities Information field in the HT/VHT/HE/EHT Capabilities elements that it transmits. An AP may also indicate its capability to receive different channel widths (smaller than the max Channel width) in the PHY Capabilities Information field in the HT/VHT/HE/EHT Capabilities elements that it transmits.

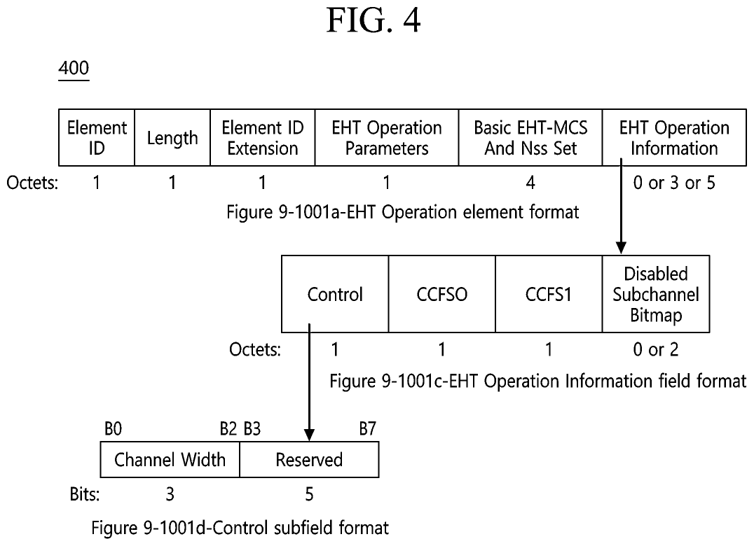

FIG. 4 is an illustrative depiction of a channel switch announcement OE 400 format. OE 400 may be segregated into a plurality of fields that are sized as octets are multiples thereof. In particular, OE 400 includes the following fields: an Element ID, a Length, an Element ID Extension, Extremely High Throughput (EHT) Operation parameters field, a Basic EHT Modulation and coding Scheme (EHT-MCS) and NSS [number of spatial streams] Set field, and an EHT Operation Information field. The first four fields are one octet in length. The Basic EHT-MCS and NSS Set field is four octets, and the EHT Operation Information field, can be 0, 3 or 4 octets depending on the particular implementation. Where present, the EHT Operation Information OE may include a pointer to a Disabled Subchannel Bitmap field which in turn may be a field in an optional EHT Operation Information subfield. The latter OE may also include a Control field, CCFS0 field, and CCFS1 field, respectively, of one octet each, with the adjacent Disabled Subchannel Bitmap extending from 0 to 2 octets. Continuing with the high-level presentation of FIG. 4, the control subfield in the EHT Operation field format has a pointer to a reserved subfield of five octets, which is adjacent to a “channel width” subfield of three octets. The first three octets are labeled B0-B2 for the channel width subfield, while the last five octets are labeled B3-B7. It was noted that if the EHT Operation Information element does not exist, then this fact obviates the need for the Disabled Subchannel Bitmap field.

The OE 400 of FIG. 4, among other features, assists in providing the maximum supported bandwidth that the STAs can use in communication with the AP. Further, OE 400 provides information about the modulation and coding schemes as well as the number of spatial streams available in the subject network configuration. In other configurations, the maximum supported bandwidth can also be changed by an AP by including the change in the Operation element present in Beacon and Probe Response frames until a time that all associated non-AP STAs have had a chance to receive the signals with the updated bandwidth information. If the change is a reduction in bandwidth, the change can be effectuated only after the time all STAs have received the update. In another configuration, the maximum bandwidth may be changed by the Operating Mode change procedure. An AP can change its receive (RX) operating mode by either: transmitting an Operating Mode Notification frame, which is a Very High Throughput (VHT) Action frame (class 3 management) or alternatively, by the AP transmitting an Operating Mode Notification element inside a beacon frame, (re) association request frame or response frame.

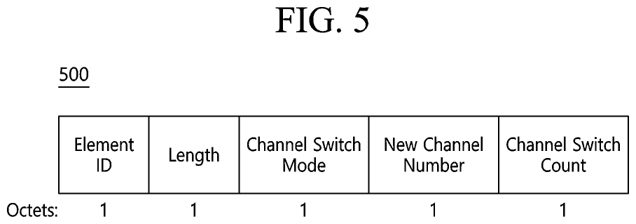

FIG. 5 is an example illustration of a channel switch announcement operation element 500. OE 500 is an element that includes five subfields of one octet each: an element ID, a length, a channel switch mode, a new channel number, and a channel switch count. In general, the channel of operation of the BSS can also be switched by an AP to a new channel. The channel switch announcement element can be used to change channels for various purposes, such as reducing interference, protecting the integrity of existing nearby connections, and the like. The channel switch announcement may be included in the beacon and probe response frames, or in a separate channel switch announcement frame, such as OE 500 of FIG. 5. Advantageously, OE 500 also records the channel switch mode and channel switch count, both of which are one-octet subfields.

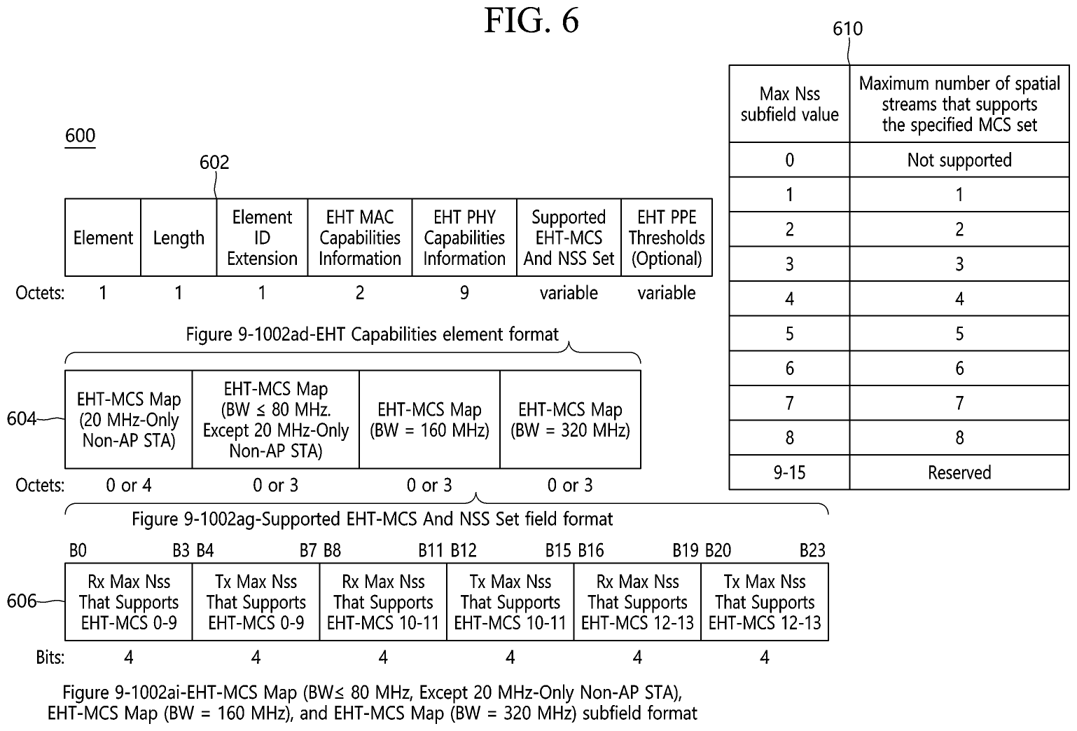

FIG. 6 is an example illustration of an extremely high throughput (EHT) capabilities operation element group 600. FIG. 6 depicts the construction of the EHT capabilities element as described in pertinent part. Initially, a larger EHT field 602 is introduced that has various subfields relevant to capabilities of EHT operation as applied to the various layers of AP-STA communication. Of particular relevance to this example of OE 602 is the variable-length subfield labeled Supported EHT-MCS and NSS set. In this implementation, the maximum number of spatial streams (NSS) that the AP can support for communication in the uplink and downlink directions for each of the support modulation and coding schemes and bandwidths is disclosed by the AP in the “EHT Capabilities element format” field 604 and, more specifically, the “supported EHT-MCS and NSS set” field 606 of the EHT capabilities element. The “HE/EHT-MCS [High Efficiency/Extremely High Throughput-Modulation Coding Scheme]” subfield of the “Supported HE/EHT MCS and NSS Set” indicates the combinations of MCS {0-13} and NSS supported by a STA for transmission and reception. Stated another way, the Supported EHT-MCS and NSS set in OE 602 includes the “EHT Capabilities Element format” field 604. For this example, the “EHT-MCS Map (BW=320 MHZ)” subfield of field 604 further includes a supported EHT-MCS and NSS Set” field 606, the latter of which specifies the maximum numbers of transmit (TX) and RX NSSs that can be obtained using the specified MCS set, such as shown in map 610. Different maps may be used for different frequency values, such as, for instance, a first map at BW=160 MHZ and a second map at BW=320 MHZ, etc. The HE/EHT capabilities element is a “per link indication” such that, when the frames are transmitted by an AP, they are mandatorily carried in the beacon frame, Association/reassociation response frame or Probe response frame.

With continued reference to FIG. 6, the supported number of spatial streams can also be quasi-statically adapted by the AP. As an example, for the AP that determines that reductions in the RX NSS are appropriate, the AP MLD may include the EHT capabilities element indicating the reduced NSS value in the beacon signal, association response and probe frames for a sufficiently long period of time to ensure that each of the STAs in the power save mode are able to receive the notification. Thereafter, the AP can reduce its NSS value. Similarly, if an increased NSS is desired, the AP can increase the NSS first and then include the EHT capabilities element indicating the increased NSS value in the beacon, association response and probe response frames. Another mechanism is via the Operating Mode change procedure. There, an AP can change its RX operating mode by either: transmitting an Operating Mode Notification frame, which is a Very High Throughput (VHT) Action frame (class 3 management) or transmitting an Operating Mode Notification element inside a beacon frame, (Re) association request/response frames.

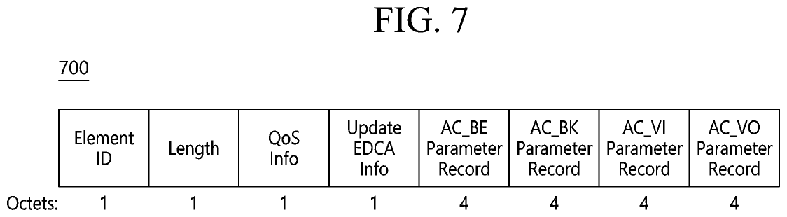

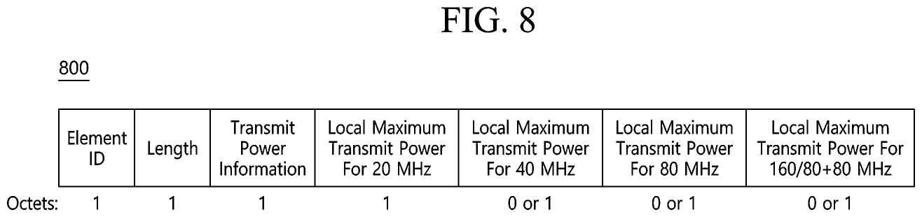

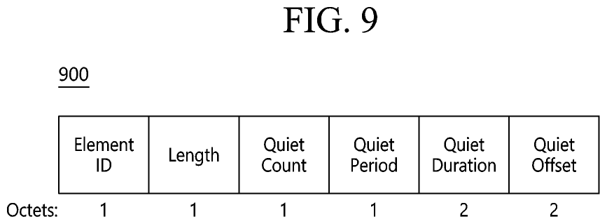

FIG. 7 is an example illustration of an enhanced distributed channel access (EDCA) set. EDCA is an extension of the distributed coordination function to support QoS for IEE The AP may indicate the EDCA parameters that may be used by a corresponding STA for the various access categories (ACs) within the beacon, association response, and probe response frames, or in EDCA parameter set frames. EDCA acts as an extension for the distributed coordination function to support quality of service for 802.11 systems. By assigning distinct backoff parameters to different access categories, differentiated throughput can be achieved even when the network is capacity is full. FIG. 8 is an example of the transmit power envelope 800 for the Wi-Fi network. The maximum transmit power that can be used by an associated STA for transmissions when operating in the AP's BSS may be disclosed by the AP to the STAs in the transmit power envelope sent in the beacon and probe response frames. For example, with reference to OA 800, the AP can provide Transmit Power information including the AP's Local Maximum transmit Power when operating at 20 MHz, 40 MHz, 80 MHz, 160 MHz, or using the 80+80 MHz scheme. Similarly, the AP can restrict the transmission of frames by its associated STAs during specific times by including a Quiet element in Beacon and Probe Response frames that it transmits. This can be used, for example, to protect incumbents, for regulatory purposes, protecting latency sensitive traffic, etc. To this end, FIG. 9 is an example of the Quiet element 900. The AP may specify a Quiet Count, Quiet Period, Quiet Duration, and Quiet offset using the subfields of element 900. The restriction of transmissions, however, need not be limited to different STAs. For example, an AP that is affiliated with a multi-link device (MLD) can also be made unavailable for a specific duration of time by the MLD by using the announced TID-to-link mapping mechanism that has been defined in 802.11be [3], cited above. The TID-to-link mapping mechanism can also be used by an MLD to disable a link on which an affiliated AP operates. Conversely, an AP that is affiliated with an MLD can also be disabled or enabled by the MLD by transmitting a Multi-link Reconfiguration element in a frame. Likewise, an AP that is affiliated with an MLD can also recommend an associated non-AP MLD to use specific links to perform transmissions in uplink and downlink directions by transmitting to a Link Recommendation Frame as defined in 802.11be [3].

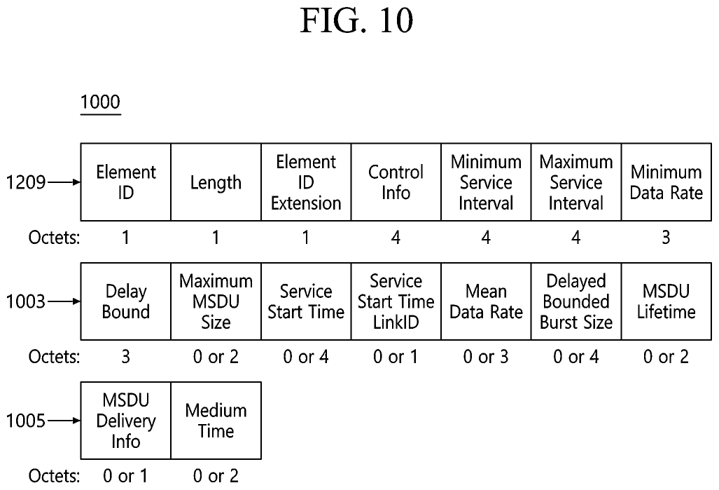

In some instances, when prevailing on a transmit opportunity (TXOP) for a specific access category, the AP may determine which of the multiple STAs should be served based on certain internal quality of service (QOS) metrics. The AP may also solicit triggered uplink transmissions from one or more STAs, with the resource allocations likewise being based on some internal quality of service (QOS) metrics. A non-AP STA can indicate to an AP the QoS requirements for its portion of traffic within a specific traffic flow, by transmitting to it a QoS Characteristics element. These objectives can be accomplished using the QoS Characteristics element 1000 defined in FIG. 10, which shows an example illustration of a QoS Characteristic Element shown by rows 1001, 1003 and 1005 of various subfields of which the AP can avail itself. This QoS characteristics element 1000 can be included in a Stream Classification Service (SCS) Request message sent from a STA to the AP, where the specific traffic flow corresponding to the requested QoS metrics can also be identified. The AP may thereafter transmit an SCS Response message to the STA indicating whether it accepts the SCS Request from the STA. If the AP accepts the SCS Request from a STA for a specific traffic flow, the AP may ensure that it performs downlink scheduling to the STA for that traffic flow such that it meets the indicated QoS requirements in the fields of the QoS Characteristic element 1000 in the SCS Request. Similarly, the AP may also enable triggered uplink transmissions for the STA for that indicated traffic flow to be able to meet the indicated QoS requirements in the SCS Request.

Examples of available QoS characteristics of FIG. 10 include, in row 1001, various applicable control information, minimum and maximum service intervals to which the AP must adhere, and minimum data rates. Exemplary QoS characteristics in the fields of row 1003 include a maximum service data unit (MSDU) size and MSDU lifetime, service start time and start time linkID, mean packet data rate, and delayed bounded burst size. Similarly in row 1005 of the QoS characteristics element 1000, MSDU delivery information and a medium time may be conveyed.

From the various available fields in the examples above, it is evident that the 802.11 family of standards are becoming richer in features, more expansive in versatility, and more accommodating of multiple links. Summarizing some of these channel access qualities discussed, WLAN is becoming replete with different categories of flexibility, only a few of which are touched on for purposes of this disclosure. In an infrastructure BSS, as noted, the AP provides wireless connectivity to the STAs that are associated with it. The AP performs scheduling of downlink and/or uplink traffic within its BSS to ensure that the demands of its clients are met satisfactorily. To control the performance of the network and to enhance and facilitate access to the network medium, the AP has evolved with various mechanisms. Nonlimiting examples include:
1. The AP can dictate the maximum bandwidth that can be used for communication with it. These details are indicated in the Operation elements transmitted by the AP in beacons.
2. The maximum supported bandwidth can also be changed by an AP by including the change in the Operation element, or using Operating Mode change procedures.
3. The channel of operation of the BSS can also be switched by an AP to a new channel by using Channel Switch Announcement procedures.
4. The maximum number of spatial streams (NSS) that the AP can support for communication in the uplink and downlink directions for each of the support modulation and coding schemes and bandwidths is disclosed by the AP in the “Supported HE/EHT MCS and NSS Set” field of the Capabilities element, discussed in greater detail above.
5. The supported NSS can also be adapted by the AP using the Operating Mode change procedures.
6. The Enhanced Distributed Channel Access (EDCA) parameters that can be used by an associated STA for the different access categories (ACs) can be indicated by the AP in the EDCA Parameter Set element.
7. The maximum transmit power that can be used by an associated STA for transmission when operating in the AP's BSS can be disclosed by the AP in the Transmit Power Envelope element.
8. The AP that is associated with a multi-link device (MLD) can also be made unavailable for a specific duration of time by the MLD by using the announced TID-to-link mapping mechanism.
9. Upon winning a transmit opportunity (TXOP), the AP may determine which of the multiple STAs should be served based on the quality of service (QOS) metrics reported by the STA using Stream Classification Service (SCS)

With significant advances in the versatility and technical capabilities of the BSS, challenges remain encountered. By way of example, the mechanisms for controlling the channel access that the AP provides can be dynamically updated based on contextual information to improve user experience. However, the AP does not have any direct mechanism to obtain such contextual information necessary for taking such actions. To exacerbate the existing limitations, several of the associated STAs of the AP may also be legacy devices which may not be capable of requesting changes in the channel access mechanisms by sending appropriate request frames to the AP. For at least these reasons, a mechanism to report contextual information to the AP that can help the AP optimize its performance for user quality of experience improvement is needed. Consequently, various aspects are disclosed herein for introducing a special STA, such as a smart home hub, to indicate its identity to the AP, and to provide the AP with contextual information that can be used by the AP to improve the user quality of experience by updating the BSS operating parameters. Contextual information provides context to a person, entity or event. Here, contextual information may provide pertinent information to the objects connected to the network, and/or to the specific events in which they are involved (e.g., controlling the light, temperature, etc.) and functions they perform (music, entertainment, security functions, etc.). Contextual information may relate to technology for providing Information Technology Assistance, or it may be driven to the functions performed by the user of the WLAN and/or the interests in which he/she may be engaged. In an embodiment, contextual information is data germane to each of the network entities, and to the network as a whole, to assist each component perform seamlessly and optimally relative to the experience of the WLAN user. The above are mere examples, and contextual information can encompass different types of data depending on the network needs, the user needs, etc.

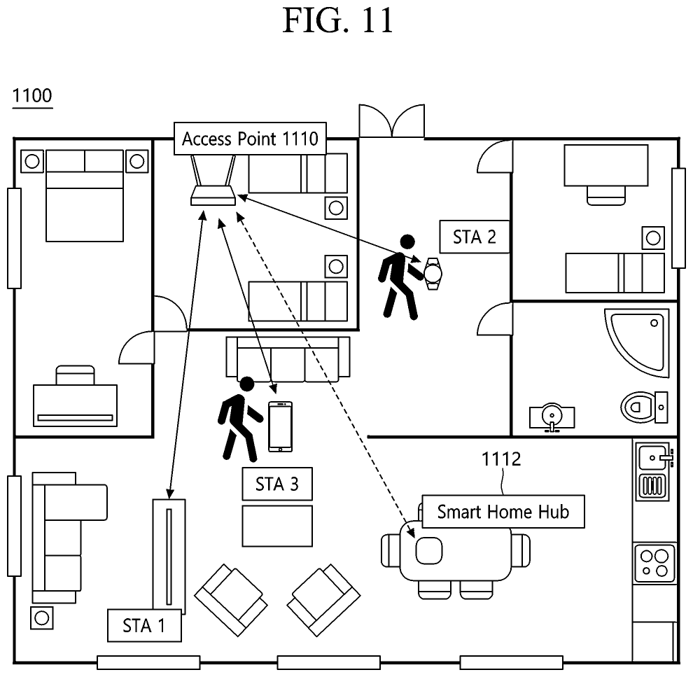

FIG. 11 is an example conceptual diagram of a system model 1100 depicting an AP, associated STAs, and a “Smart Home Hub” for providing contextual information to the AP, in accordance with an embodiment. Initially it should be noted that the SHH is typically connected to the WLAN; accordingly, it is also referred to and differentiated herein as a HOST STA. STAs that are not HOST stays are non-host stays. For example, a non-AP STA that is not a host or a smart host hub is a STA in a network. FIG. 11 shows an example residence in which the WLAN is implemented. The WLAN model 1100 includes in this example one AP, one special STA coined a “Smart Home Hub” (SHH) 1112 and one or more other STAs (STA1, STA2, etc.) affiliated with the AP, each having a QoE to be optimized. Here, the SHH 1112 is the device that obtains the contextual information using one or more methods, and then feeds appropriate portions of that information to the AP for optimizing the QoE. Contextual information is any relevant information that can be extracted from the environment in active or passive ways-most notably, in this example, including data from the network and data obtained from external sources through transducers or digital electronic devices (e.g., security system, thermometer, smoke detector, and the like, depending on factors like the complexity of the implementation). The AP 1110 may be the central source for data and may be hardwired to a fast external network via hardware interfacing with the AP 1110, e.g., through a coaxial or fiber cable, or a satellite dish. For illustrative purposes, the AP 1110 is positioned in one of the bedrooms, but if the environment or model 100 is a house, the AP 1110 can be positioned in any convenient location. Further, the SHH 1112 is stationed in this example on the dining room table, although placement is arbitrary and may be in another location.

In one aspect of the disclosure, SHH 1112 may have determined the make or model of the AP based on information received in one or more of the various fields, including vendor-specific fields, of the Probe Response and Association Response frames from the AP. Based on the received information in these frames, the Smart Home Hub may perform association with an appropriate AP which is capable of receiving and acting upon contextual information sent by SHH 1112. SHH 1112 may also disclose its make and capabilities using the vendor-specific elements of the Probe Request and Association Response frames that it sends to an AP. In an embodiment, rather than using vendor specific elements, the above information may be disclosed by the AP in the MAC capabilities element that the AP includes in Beacons, Probe Response and Association Response frames. Similarly, SHH 1112 may disclose its capabilities using the MAC Capabilities element it includes in Probe Request and Association Request frames sent by SHH 1112 to the AP.

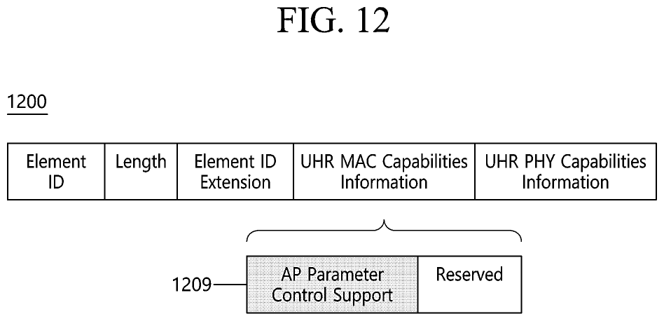

For example, the make and/or model information may be relayed using an ultra-high reliability (UHR) Medium Access Control (MAC) Capabilities Information element. FIG. 12 is an example illustration of a UHR element 1200 including a subfield called UHR MAC Capabilities Information. Within that UHR MAC Capabilities subfield, an AP Parameter Control Support element 1209 is present in accordance with an embodiment. In element 1209, a bit field within the UHR MAC Capabilities Information field in can be set to a value of one, for example, to indicate that the non-AP STA (e.g. SHH 1112) is capable of requesting parameter control for AP 1110 to impact AP operation relative to one or more other STAs. Similarly, in the UHR MAC Capabilities Information element included by AP 1110 as part of the UHR Capabilities element 1200 that AP 1110 transmits, a bit called AP Parameter Control Support can similarly be set to a value of one, for example, to indicate that AP 1110 is capable of receiving requests from authorized STAs (e.g., SHH 1112) to control the AP's operation with one or more other STAs. In an alternative configuration, this field can be called the Proxy SCS Support field. It should be understood that the relative number of bits, the value of those bits, and the identity of the field may vary without departing from the scope of the present disclosure.

Obtaining Authorization From AP BY SHH. In various embodiments, the SHH may send a message or frame to the AP to request authorization to provide contextual information to the AP and control some of the BSS parameters indirectly for one or more associated STAs. This can be called, for example the AP Parameter Control Request message, illustrated below. This request optionally may be initiated using an Application Layer protocol that is initiated by a user, for example, using an App, on behalf of the SHH. The AP may further verify the credentials of the SHH using an AP-specific App at the Application Layer to assess whether the SHH is authorized for performing such control. In some embodiments, the AP may also send a notification message to one or more associated STAs, to verify whether they are willing to comply with the SHH controlling their specified parameters or for other inquiries. The associated STAs may thereupon send a response frame to the AP to indicate if they approve the Smart Home Hub controlling their specified parameters. If the request is approved, the AP may be sent an appropriate approval response to the Smart Home Hub, called AP Parameter Control Response message, also discussed below. The response may also indicate a list of STAs which have approved control by the SHH. In some examples, the AP may send an appropriate approval response via the Application Layer to the user App, which then sends a frame to the SHH confirming the approval. In case the request is rejected, the AP may also include a Status Code field to indicate the reason for the rejection. As part of the negotiation, the AP and SHH may also negotiate secure signaling mechanisms between themselves that are highly protected from being spoofed by a malicious third party. The negotiation between the SHH and the AP to obtain authorization to control some of the BSS parameters for one or more associated STAs may in other embodiments be performed at the MAC layer via signaling defined in the Wi-Fi standard.

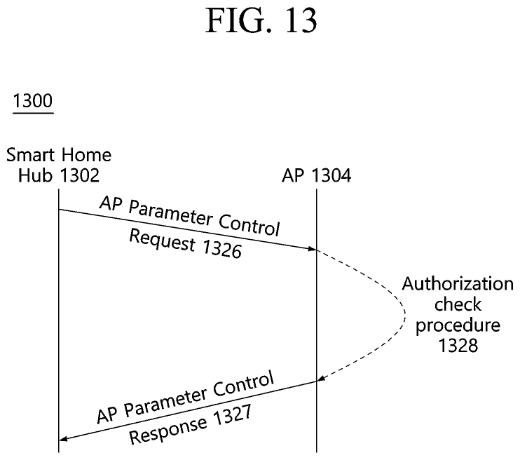

FIG. 13 is an example signaling diagram 1300 illustrating an exchange between the Smart Home Hub (SHH) 1302 and an AP 1304 to secure approval by the SHH to interact with the AP in some designated authorized way. It should be noted that the Smart Home Hub 1302 may refer to SHH 1112 of FIG. 11, and that AP 1304 may refer to AP 1110 in the example diagram of FIG. 11. Thus, in another aspect of the disclosure with reference to FIG. 13, SHH 1302 may send a message or frame (here, AP Parameter Control Request 1326) to the AP 1304 to request authorization to (i) provide contextual information to the AP and (ii) control certain of the relevant BSS parameters indirectly for one or more associated STAs, such as STAs 1-3 in the example model 1100 of FIG. 11. In various embodiments, this request may be initiated by a user via an Application Layer protocol. The protocol may be installed on SHH 1302 and the message sent to AP 1304 on behalf of the SHH. After the AP Parameter Control Request 1326 is received, the AP 1302 proceeds to undertake an authorization check procedure 1328. For example, AP 1302 may further verify the credentials of SHH 1304 using an AP-specific application at the Application Layer. Verification ensures that the request in the message is authorized for allowing such control. Verification may optionally be automated, or manual such that some user action (e.g., depression of a switch) is needed. In one embodiment, this parameter is adjustable by accessing a Settings menu and specifying “automatic verification” versus manual verification for the subject application. In some embodiments, as part of the authorization check procedure 1328, the AP may also send a notification message to one or more associated STAs (e.g., STAs 1-3 in FIG. 11), to verify that they authorize imparting partial control to SHH 1302 over the subject parameters. Upon receiving and evaluating the authorization request(s), the associated STAs may in turn send a response frame to the AP to indicate whether they approve SHH 1302 controlling their specified parameters. For example, if the requests are approved and the authorization check procedure 1328 is successful, the AP 1304 may transmit an AP Parameter Control Response message 1327 back to SHH 1302 indicating the status or scope of permissions. The response may also indicate a list of STAs which have approved control by the Smart Home Hub. In a variant, AP may be sent an appropriate approval response via the Application Layer to the user App, which then sends a frame to the SHH 1302 confirming the approval. In case the request is rejected, the AP 1304 may also include a Status Code field or similar such message to indicate the reason for the rejection. An illustration of this frame exchange sequence is depicted in FIG. 12.

In some embodiments, as part of the negotiation between the AP 1304, SHH 1302 and certain other STAs, the devices may also negotiate secure signaling mechanisms between themselves that are highly protected so that they cannot likely be spoofed by a malicious STA. In a similar embodiment, the negotiation between the SHH and the AP to obtain authorization to control some of the BSS parameters for one or more associated STAs may be performed at the MAC layer via signaling defined in the Wi-Fi standard, rather than over an application layer. In other embodiments, different mechanisms can be put in place to verify the integrity of the request, and each such procedure is deemed to be included with this disclosure.

In alternative or additional embodiments, SSH 1302 may also disclose a list of the different types of requests that it may want to send to the AP as part of this parameter control request. These may include, by way of example and without limitation:
setting up or removing of a virtual BSS with a specific password and username
enablement or disablement or unavailability of one or more APs of an AP MLD based on a requirement
increasing or reducing the maximum supported bandwidth or NSS of an AP
changing the EDCA parameters to be assigned by an AP to all or a subset of its associated STAs
changing the QoS criteria to be used by an AP for all or a subset of its associated STAs and for all or specific traffic flows to/from those associated STAs (The flows can be specified using, for example, the traffic classification (TCLAS) element. In another case, the type of flows to be controlled may be predetermined, such as those originating from a specific source MAC address.)
changing the transmit powers that can be used by the AP and/or one or more of its associated STAs
changing the operating channel or initiating a search for a better operating channel for the APs BSS
restricting the transmission of frames in uplink and/or downlink direction for specific intervals, etc.
collecting statistics of data transmissions for one or more associated STAs and reporting it to the SHH

In other embodiments, a list or a bitmap field can be generated or maintained, with entries corresponding to all possible commands that can be sent. For example, a one-bit field can be associated with each entry. The value of the bit can be set to a value of one if the SHH anticipates providing such a command, feature or operation during the relevant time period corresponding to the activation of the authorized devices. The field may be set to 0 otherwise, if the command, feature or operation is not expected to be activated. The source, location and generation of this table or bitmap can vary depending on the configuration. In some embodiments, this information can be transmitted by the SHH either in a new Action frame(s), a vendor specific element or action frame, using an Application Layer handshake, and the like. Similarly, in the corresponding response frame sent by the AP, all or a subset of the requested commands may be approved and accepted ones can be indicated using an appropriate bitmap. In an implementation, the SHH may also generate and circulate a list of associated STAs from which the SHH can receive requests. These STAs may be identified, for example, using their association IDs (AIDs), or MAC addresses. In the response frame sent by the AP, all or a subset of the requested STAs may be indicated as the STAs for which parameter control by the Smart Home Hub is approved.

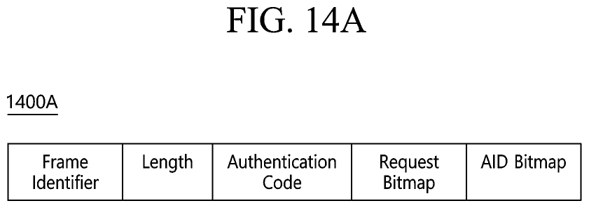

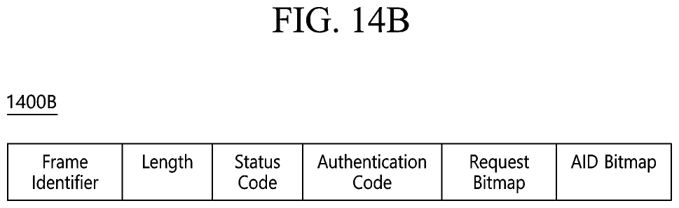

FIG. 14A is a frame 1400A in a wireless local area network for carrying information relevant to an AP Parameter Control Request message, in accordance with an embodiment. Here, the Frame Identifier may contain a unique code to identify that the message is the AP Parameter Control Request message, e.g., being transmitted by a STA such as SHH 1112 (FIG. 11). The Length field may indicate the length of the message. The Authentication Code field can include a code that may be used by the receiving AP to verify the credentials of the SHH and provide authorization to the SHH. The Request Bitmap field can be a bitmap with each bit indicating the status for a different type of request described above. The AID bitmap can have the same format as the AID Bitmap element in Reference (3) IEEE P802.11be/D3.0. The AID bitmap can be used to identify the STAs for which the parameter request can be sent by the SHH. It is noteworthy that there may be alternative or additional fields not depicted specifically in FIG. 14A, including without limitation a transmit address and receive address for the message. In the case where the message exchange is executed using Action frames or vendor specific elements, the Frame Identifier and Length fields may be replaced by other fields defined for these frames, e.g., the MAC header fields, Category, Action fields articulated in (1) IEEE 802.11-2020, “Wireless LAN Medium Access Control (MAC) and Physical Layer (PHY) Specification,” or other sources. FIG. 14B is an example frame 1400B for an AP Parameter Control Response described in FIG. 13 and sent by the AP to the SHH. In this example, the Status Code field may indicate the status of the request sent in frame 1400A by the SHH, e.g., accepted, rejected, alternatives suggested, error code, and the like.

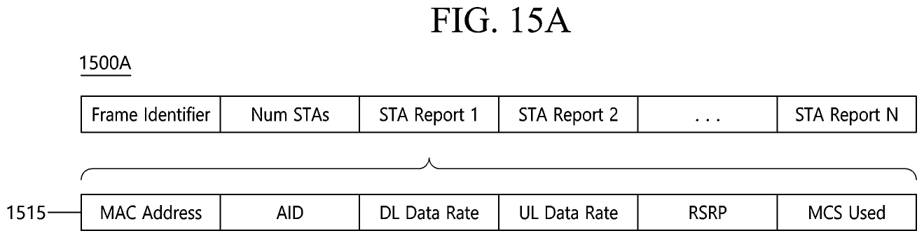

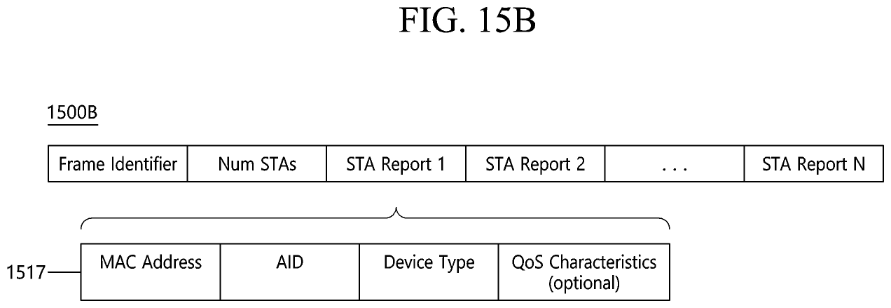

In a further implementation, after successful authorization via completion of the signaling diagram 1300 of FIG. 13 or through use of another similar exchange, the SHH may send a new action frame or a vendor-specific action frame to the AP to request a list of STAs that are associated with the AP. The AP may respond to the SHH's new request by transmitting an “Associated STA Report” message indicating the MAC addresses, AIDs, average data consumption and/or other parameters for all or a subset of its associated STAs. In some embodiments, part or all of this information exchange can be performed at an application layer between a user application and the AP vendor application. In another case, the exchange can be performed at the MAC layer using new action frame or a vendor-specific action frame. FIG. 15A is an illustrative example of an Associated STA Report 1500A sent by an AP based on a request from a SHH, in accordance with an embodiment. In this example, the Frame Identifier identifies the Frame as being an Associated STA Report, the Num STAs field indicates the number of STAs reported, and for each such STA a STA Report field 1515 can be included with an indication of the STA details such as the MAC Address, the AID, average downlink/uplink Data rates experienced, reference signal received power (RSRP) from AP, average Modulation and Coding Scheme (MCS) used for transmission, etc. Note that in the case where the message exchange is done using Action frames or vendor specific elements, the Frame Identifier and Length fields there may be replaced other fields defined for these frames, e.g., the MAC header fields, Category, Action field from the reference (1) cited above.

In various embodiments, the SHH may also send a message to the AP indicating the device type of one or more STAs associated with the AP. FIG. 15B is an example of a frame 1500B for illustrating the device type report sent by a SHH to an AP to identify the device types of one or more associated STAs, in accordance with an embodiment. Here the device may be identified by its MAC address, and the device type may be, for example, Visual Display, Audio Device, a Smart phone, Laptop, Internet-of-things device, low-power device, etc. In an implementation, all or part of this information exchange can be performed at an application layer between a user App and the AP vendor App. In another implementation, the exchange can be performed at the MAC layer using new action frame or a vendor-specific action frame. An illustrative example of this Device Type Report frame message 1500B is depicted in FIG. 15B. In this example, the Frame Identifier identifies the frame as being a Device Type Report, the Num STAs field indicates the number of STAs reported, and for each such STA a STA Report field can be included (e.g., STA Report 1, STA Report 2, STA Report N) with an indication of the STA details subfields 1517 such as the MAC Address, the AID, the Device Type of the STA and the QoS Characteristics to be applied for the traffic flowing to and from the STA. Note that in the case where the message exchange is effectuated using Action frames or vendor specific elements, the Frame Identifier and other fields that are currently present but no longer needed may be replaced other fields defined for these frames, e.g., the MAC header fields, Category, Action fields, etc.

In other embodiments, the SHH may obtain contextual information to update one or more of the BSS or AP's parameters. This contextual information can be obtained by any of several features, a few of which are noted here:
Audio/voice command by an authorized user.
Application layer command by a user via an Application.
A trigger generated by an Application, such as a wireless sensing app.
By passively observing the wireless medium.
Observing the data/traffic flows generated by the SHH.

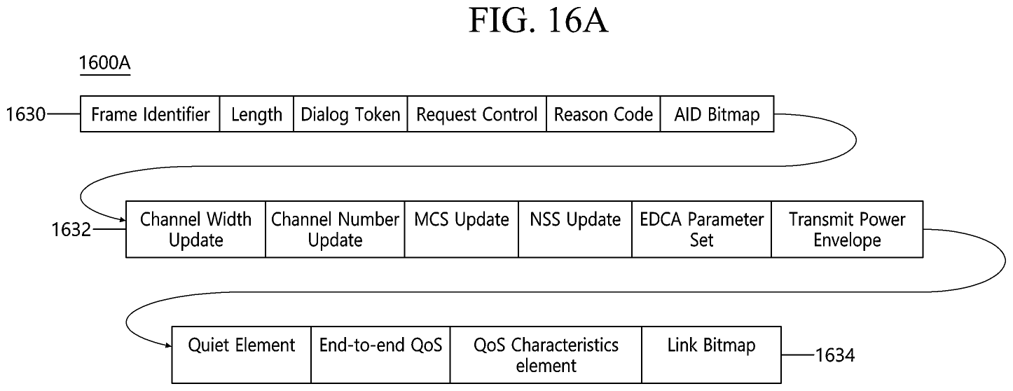

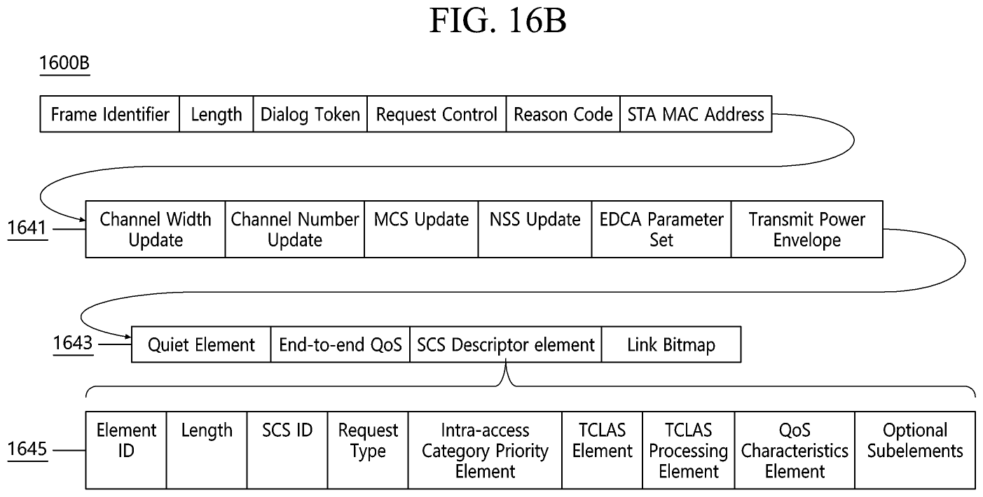

In further embodiments, based on contextual information, the appropriate determined action may be indicated to the AP by sending a new action frame, vendor specific action frame or an Application layer message. Two examples of this AP Action Request message are depicted below. FIG. 16A depicts an illustration of an AP Action Request message 1600A where a QoS Characteristic element is directly included, in accordance with an embodiment. Similarly, FIG. 16B depicts an illustration of an AP Action Request message 1600B, but where the QoS Characteristic is carried in a Stream Classification Service (SCS) Descriptor element. It is noteworthy that the action message 1600A as shown in rows 1630, 1632 and 1634 for convenience) is otherwise substantially identical to action message 1600B in FIG. 16Bm, as defined in rows 1600B, 1641, and 1643. The key difference is the presence of the additional row of subfields 1645 in FIG. 16B.

Referring to FIG. 16A, the Frame Identifier of a first section of frame 1630 may contain a unique code to identify that the message is an AP Action Request message. The Length field may indicate the length of the message. The Dialog token field may be a unique identifier for each request message. The Request Control field may indicate which optional fields are present within the message. The Reason Code may indicate the reason the request is being made. The AID Bitmap or STA MAC Address fields may be used to identify the one or more STAs for which the request is applicable. Referring to the second row 1632 in the same message (segmented for visual practicality), the Channel Width Update field may indicate the new BSS channel width requested. The Channel Number Update field may indicate a request to switch to a new channel indicated by the channel number. The MCS Update field can be used to request an update to the maximum MCS supported. The NSS Update field can be used to request an update to the maximum number of spatial streams (NSS) supported. The EDCA Parameter Set field can have encoding as the EDCA Parameter Set element (described in reference (1), cited above) and can be used to request an update to the EDCA parameters for the BSS. The Transmit Power Envelope field can be used to request a change in the maximum allowed transmit powers by the STAs. Referring now to the third row 1634 of the message, the Quiet Element can have a format as cited in reference (1), above. The Quiet Element can be used to silence the BSS for specific intervals. The End-to-end QoS field can indicate whether or not any included QoS parameters are applicable for end-to-end traffic. The QoS Characteristics element or SCS Descriptor element are used to indicate the QoS Parameters and stream classification filters that are requested to be applied for the indicated STAs. The Link Bitmap may be used to request updates to the links to be used for transmission (in case of multi-link operation). Each such request sent by the Smart Home Hub may be uniquely identified by a Dialog Token. It should be noted that while the Action message is illustrated as a large frame with several fields, this need not be the case and in some embodiments, the message may be partitioned into more than one frame, or the message may be packetized in some other way.

For example, the transmitted message can request any of the following, by way of example. However, the list is not meant to be exhaustive, and other subject matter not specifically discussed here may be equally suitable for purposes of this disclosure.
1. If the expected future traffic will be low, to save the AP power, the SHH may request the AP to reduce its operating bandwidth, NSS or number of enabled links, or make some links unavailable. These can be requested, for example, using the Channel Width Update, NSS Update and Link Bitmap fields of the AP Action Request message.
2. If the expected traffic in near future is high, the SHH may request the AP to increase its operating bandwidth, NSS or number of enabled links. These can be requested, for example, using the Channel Width Update, NSS Update and Link Bitmap fields of the AP Action Request message.
3. If the expectation is to create a new virtual BSS with a set BSS name and password or close down a virtual BSS, the Home Hub may indicate the same to the AP.
4. If the AP traffic is causing high interference to another user-deployed network operating in parallel, SHH may request AP to perform a channel switch, reduce the BSS's maximum transmit power, or transmit a quiet element to protect the transmissions of the user-deployed network. These actions can be requested using the Transmit Power Envelope or Quiet Element fields of the AP Action Request message 1600A.
5. If a particular critical STA's performance is suffering and needs to be improved, SHH may send a QoS characteristics element to the AP on behalf of that STA or may ask the AP to prioritize traffic to that STA by scheduling or EDCA parameter updates. This information can be carried, for example, in the QoS Characteristics element of the AP Action Request message 1600A in FIG. 16A. In another case, both the QoS and the traffic flow for which the QoS is applicable may be identified by including a Stream Classification Service (SCS) Descriptor element (depicted in FIG. 16B). The flow may correspond to downlink traffic to the critical STA, uplink traffic to the critical STA and/or peer-to-peer traffic to the critical STA (originating from another peer device such as SHH itself). In one embodiment, the QoS parameters may include requirements on throughput, delay bound, or service interval, etc., on the traffic service from the AP to the STA, or vice versa. In another configuration where the source and destination of the traffic flow belong to the same BSS as the AP, then the indicated QoS parameters may include requirements on throughput, delay bound, or service interval, etc., on the end-to-end traffic from source to destination. This distinction can be indicated using the End-to-end QoS field in row 1634 of FIG. 16A. Here, the AP Action Request message can also be a variant of the Stream Classification Service (SCS) Request frame (FIG. 16B).
6. If a particular STA is about to turn on soon, the Home Hub may send an association request message on behalf of the device to the AP to speed up the process.
7. If a particular STA is about to cross a coverage limit or go into a coverage hole, the Home Hub may request the AP to lower the MCS to be used, increase the transmit power or send a BSS Transition Management Request frame to the STA to help it hand-over to another AP. This can be indicated using the MCS Update field or Transmit Power Envelop field of the AP Action Request message.
8. If a particular STA performance needs to be optimized, the Hub may request the AP to collect certain metrics of the data for the STA, e.g., average inter-packet arrival rate or average inter-packet jitter etc. and report it to the Hub or to the STA. This may include, for example, reporting of a TSPEC element by the AP.

With brief reference to FIG. 16B, it is noteworthy that the row of subfields 1645 can be thought to be subsumed within the SCS Descriptor element in row 1643 of the action message 1600B. That is, the row 1645 of subfields are part of the SCS Descriptor element field.

When the Smart Home Hub indicates a specific QoS to be applied to a specific flow of traffic to an associated STA, the AP may either:
directly perform downlink or triggered uplink scheduling to the STA to satisfy indicated QoS parameters. The AP may also optionally send an unsolicited SCS Response frame to indicate the same to the STA,
first send an SCS Request/Notification frame to the corresponding STA indicating that it intends to install the specified QoS characteristics for it, and upon receiving an SCS Response frame from the STA, the AP may perform scheduling accordingly for that traffic flow.

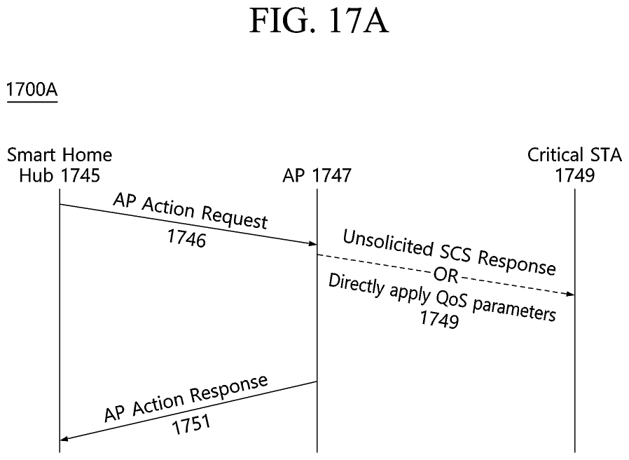

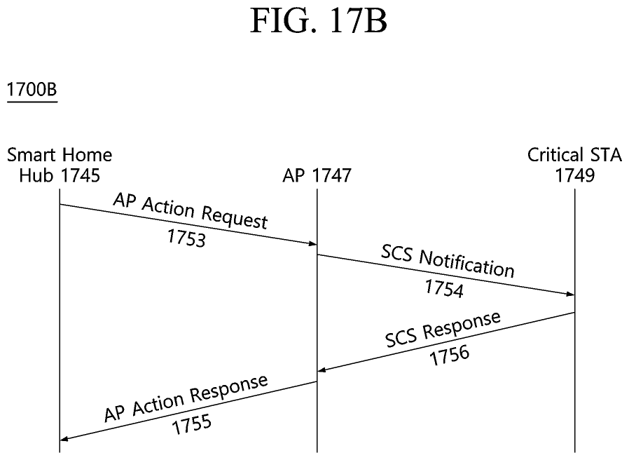

Addressing the first option, FIG. 17A is a signaling diagram 1700A showing Quality of Service (QOS) provisioning of a STA without eliciting a confirmation from the STA (the first option), in accordance with an embodiment. Three devices are illustrated, including SHH 1745, AP 1747 and a Critical STA 1760. SHH 1745 may transmit an AP Action request 1746, as described above. Upon receipt of the AP Action request 1746, the AP 1747 may elect to immediately perform resource scheduling for enabling data exchanges with Critical STA 1753 or directly apply QoS parameters as in 1749. Thereafter, AP 1747 sends an unsolicited SCS Response to the Critical STA. The procedure is complete when AP 1747 transmits an AP Action Response 1751 to SHH 1745.

Addressing the second option, FIG. 17B is a signaling diagram showing QoS provisioning of a STA upon receiving a confirmation from the STA, in accordance with an alternative embodiment. The same three devices, SHH 1745, AP 1747, and Critical STA 1760, are illustrated. The AP 1745 sends an initial AP action Request 1753 to AP 1747. This time, rather than act directly by scheduling a grant or provisioning SOS resources, AP 1747 transmits an SCS notification 1754 to Critical STA 1760 that it intends to install the specified QoS characteristics. Upon receiving a confirmation from the Critical STA 1760; herein the form of an SCS Response 1756, the AP 1747 sends an AP Action Response 1755 back to SHH 1745 and allocates the traffic flow with the QoS requirements at issue to the Critical STA 1760,

One benefit of the case of uplink transmissions (triggered or untriggered) is that the indication of the QOS characteristics to the critical STA can help the critical STA differentiate/prioritize between the different buffered traffic to be included in the transmission based on the QoS requirements.

In another aspect of the disclosure, SHH may provide the action that should be taken by the AP along with, in some cases, a reason for the action. With this knowledge, the AP may either take the requested action, perform an alternative action deemed more appropriate under the circumstances, or reject the request.

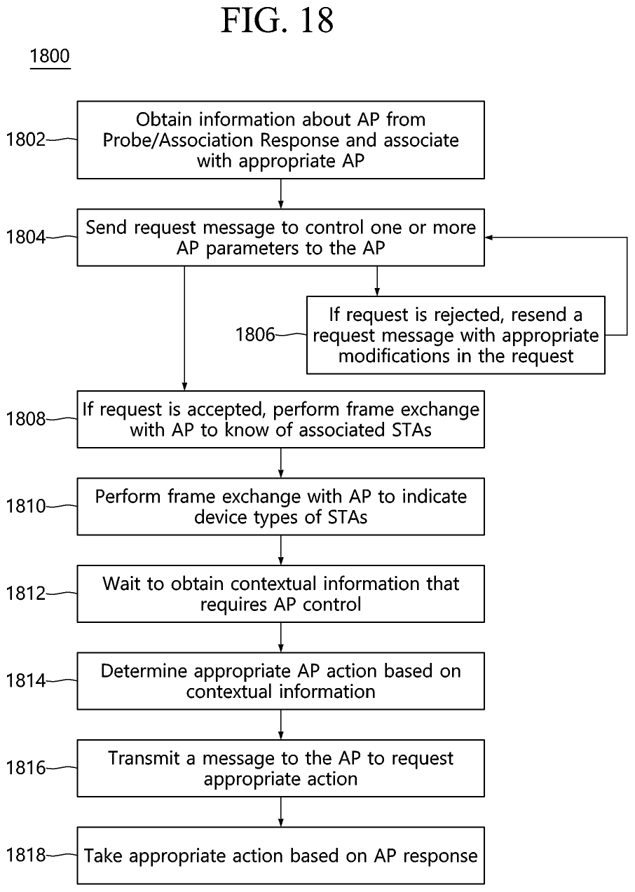

FIG. 18 is an illustrative flow diagram 1800 representing methods of the disclosure, in accordance with an embodiment. The device performing the functions of FIG. 18 may be the SHD. Referring initially to 1802, the SHD may obtain information about the AP from a probe/association response, so that the SHD can identify and associate itself with the proper identification. At 1804, the SHD may thereupon send a request message to the AP to control one or more of the AP's parameters. If at 806 the AP rejects the request, there may be some reason or logic behind the denial, in which case the SHD may resend the request with suitable modifications. If at 1808 the request is ultimately accepted, the SHD may proceed to exchange frames with the AP to learn about the STAs that are connected to the AP. This information may be accompanied by the device type (1810) of the one or more STAs found, and other criteria such as whether MLO is involved. At 1812, the SHD may be idle until it recognizes the presence of contextual information that needs AP control. Should there be more than one AP with which the SHD is associated, then at 1814, the SHD may determine the appropriate AP action based on the newly identified contextual information in 1812. At this point, the SHD may determine at 1814 an appropriate action that the AP can inform to request that appropriate action be taken in view of the contextual information. At 1816, the SHD may transmit a message to the AP to request the determined appropriate action. Thereafter, it may be assumed that the AP has made one or more modifications to the network. The AP may thereafter respond at 1816 to the SHD. Depending on the particular circumstances, the SHD may elect to take some appropriate action based on the AP response. For example, if the intent of the initial request was to turn off music reproduced over a set of AP speakers, the AP's message may confirm that the music has stopped playing. The action of the SHD at 1818 may be a simple request to the AP to power off the speakers. In other instances, such as those involving multiple links, the action and events may be more specific.

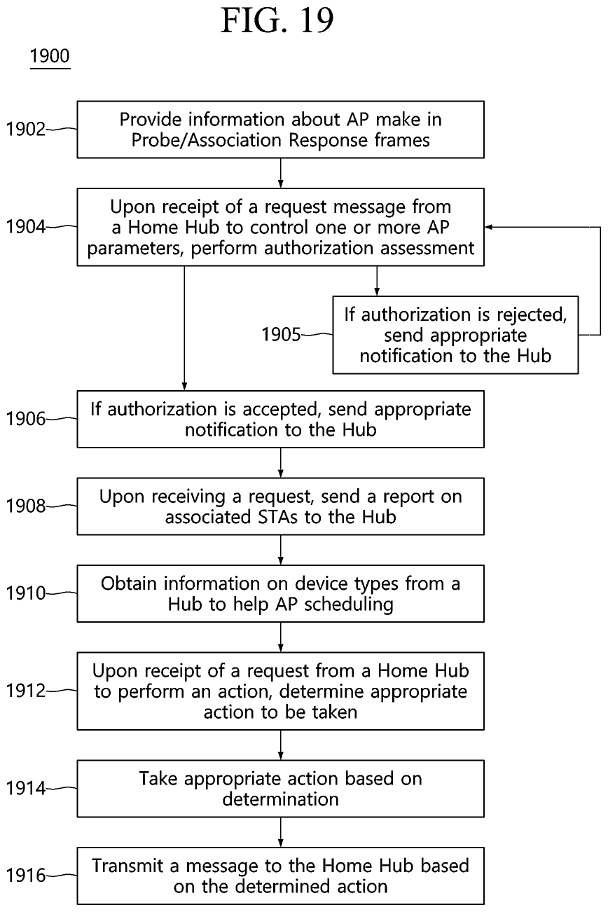

FIG. 19 is another illustrative flow diagram representing methods of the disclosure, in accordance with an embodiment. The method of FIG. 19 may be performed by the AP. Beginning at 1902, the AP may provide information about its make in Probe/Association Response frames. In other embodiments, this information may be provided in custom fields specific to the AP manufacturer. At 1904, after the AP has received from an SHH a request message to control one or more of the AP's parameters, the AP may proceed to perform an authorization assessment to ascertain whether the request is legitimate. If for any reason the request is denied (such as where the SHH is unauthorized to perform the requested action), at 1905 the AP may issue an appropriate notification to the SHD regarding the rejection. With reference to 1906, in the event the SHD is deemed authorized and the request is accepted, the AP may send an appropriate notification to the SHD apprising the SHD of the status of the request.

At 1908, upon receiving a request from the SHD, the AP may send a report identifying the STAs associated with the AP's wireless network to the hub. The report may be in the form of a list, a bitmap, a series of frames, etc. Separately, at 1910, the AP may obtain information on device types from the SHD to assist the AP is scheduling. This scheduling may include optimizing procedures according to SHD preferences, or providing higher privileges to specific devices in order to facilitate the operation of the SHD. This scheduling may also entail using the device types to plan out future operations or procedures that may subsequently take place. Referring to 1912, the AP may receive a request from the SHD to perform an action, or to determine an appropriate action to be taken at some future time, for example. The action may be one that is in furtherance of optimizing the operation of the network to achieve the goals of the SHD. At 1914, the AP takes the appropriate action based on the determination made in 1912. In addition, at 1916, the AP may transmit a message to the SHD based on the determined action. Thus, for example, the message may be to update the SHD that the action has been taken. In other embodiments, the message may include details about the action taken. In still other examples, the message may include details about potential future actions for the AP to take, or the message may be part of a status report to the SHD that may identify other actions or future intended actions, thereby enabling the AP and the SHD to coordinate with each other.

FIGS. 18 and 19 are exemplary in nature and demonstrate some of the details and capabilities of the AP and SHD. FIGS. 18 and 19 are not intended to limit the disclosure to the embodiments described therein. Other operations, procedures, and events (including different orders of events) may be equally applicable to further the objectives of the present disclosure.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner like the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. The described instructions, operations, and systems can be integrated together into a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP), comprising:
a memory; and
a processor coupled with the memory and configured to:
receive, from a host station (host STA), a parameter control request that requests authorization to provide contextual information to the AP and control one or more basic service set (BSS) parameters for one or more stations (STAs) associated with the AP;
transmit, to the host STA, a parameter control response that indicates authorization to the parameter control request; and
receive, from the host STA, contextual information associated with one or more BSS parameters for the one or more STAs.

2. The AP of claim 1 wherein, based on the contextual information, the processor is further configured to control the transmission and scheduling parameters for one or more STAs and the BSS parameters.

3. The AP of claim 1, wherein the processor is further configured to transmit to the host STA one or more frames comprising information associated with a make of the AP and a capability of the AP to receive parameter control requests from the host STA.

4. The AP of claim 1, wherein the processor is configured to perform an authorization check upon receiving the parameter control request from the smart hub before responding to the parameter control request.

5. The AP of claim 1, wherein the parameter control request includes an authentication code, and one or more request types or identifiers of one or more STAs associated with the AP for which the request is applicable.

6. The AP of claim 1, wherein upon receiving the authorization, the processor is configured to send an associated STA report to the host STA identifying one or more STAs associated with the AP and parameters of the AP including link characteristics and traffic characteristics.

7. The AP of claim 1, wherein the processor is configured to receive from the host STA a device type report identifying types of the one or more STAs associated with the AP and parameters of the AP including traffic characteristics.

8. The AP of claim 1, wherein the processor is configured to receive the contextual information via an action request message from the host STA to perform an action on the BSS parameters or on the one or more STAs on behalf of the host STA, the action including:
(i) setting up or removing a virtual BSS using login credentials; (ii) enabling or disabling availabilities of one or more STAs in the wireless network; (iii) enabling or disabling links with any of the one or more STAs if the STA is a multi-link device (MLD); (iv) increasing or decreasing a maximum supported bandwidth or number of spatial streams of the AP; (v) changing quality of service (QOS) criteria used for the at least one STA for all or designated traffic flows to the at least one STA of the one or more STAs; (vi) changing transmit power for signals sent from the at least one STA, (vii) changing an operating channel with the host STA; or (viii) restricting transmission of uplink or downlink frames for a specified time interval to or from the at least any of the STAs.

9. The AP of claim 8 wherein upon determining the appropriate action to take based on the shared contextual information, and based on the determination, the processor is configured to send an action response message to the host STA to indicate a result of the determination.

10. The AP of claim 8, wherein upon receiving an action request message to change transmission and scheduling parameters for at least one associated STA, the processor is configured to send a notification message to the at least one associated STA to indicate the change in parameters.

11. A host station (host STA), comprising:
a memory; and
a processor coupled with the memory and configured to:
transmit, to an access point (AP), a parameter control request that requests authorization to provide contextual information to an AP and control one or more Basic Service Set (BSS) parameters for one or more stations (STAs) associated with the AP;
receive, from the AP, a parameter control response that indicates authorization to the parameter control request; and
transmit, to the AP, contextual information associated with one or more BSS parameters for the one or more STAs.

12. The host STA of claim 11 wherein the processor is further configured to propose changes to information transmitted by the AP in a wireless network based on the transmitted contextual information.

13. The host STA of claim 11, wherein the processor is further configured to receive from the AP one or more frames comprising information associated with a make and capabilities of the AP to receive parameter control requests.

14. The host STA of claim 11, wherein the authorized parameter control response enables the host STA to receive action control responses seeking particular types of contextual information.

15. The host STA of claim 11, wherein the parameter control request includes an authentication code, one or more request types, and identifiers of one or more STAs associated with the AP for which the request is applicable.

16. The host STA of claim 11, wherein the processor is configured to transmit an AP action request message to provide the AP with recommendations for taking different actions responsive to different network criteria and conditions.

17. The host STA of claim 16, wherein upon receiving control response, the processor is configured to send an associated STA report to the host STA identifying one or more STAs.

18. The host STA of claim 11, wherein upon the processor identifying a critical STA of the one or more STAs having substandard performance that requires immediate improvement, the processor is configured to transmit the Quality of Service (QOS) requirements to the AP on behalf of the critical STA.

19. The host STA of claim 18, wherein the QoS requirements are carried in the Quality of Service (QOS) characteristics element of the AP Action request message.

20. The host STA of claim 18, wherein the QoS requirements along with the identifiers of the one or more affected traffic flows of the critical STA are carried in a Stream Classification Service (SCS) descriptor element of the AP Action request message.
